(19) United States
(12) Patent Application Publication
(10) Pub. No.: US 2026/0320964 A1
(43) Pub. Date: Oct. 15, 2026

(54) Parameter Efficient Fine-Tuning of Large Vision Foundational Models for Multi-Channel Medical Image Segmentation

(71) Applicant: Bristol-Myers Squibb Company, Princeton, NJ (US)

(72) Inventors: Kaushik Dutta, Princeton, NJ (US); Devansh Agarwal, Lawrenceville, NJ (US)

(73) Assignee: Bristol-Myers Squibb Company, Princeton, NJ (US)

(21) Appl. No.: 19/644,079

(22) Filed: Apr. 10, 2026

Related U.S. Application Data
(60) Provisional application No. 63/787,171, filed on Apr. 11, 2025.

(51) Int. Cl. G06V 10/26; G06V 10/764; G06V 10/774; G06V 10/776; G06V 10/82; G06V 20/64

(52) U.S. Cl. CPC G06V 10/26; G06V 10/764; G06V 10/774; G06V 10/776; G06V 10/82; G06V 20/64; G06V 2201/03

(57) ABSTRACT

A method includes modifying a pre-trained image encoder by incorporating, into the pre-trained image encoder, a plurality of channel-wise adapter modules. The method also includes obtaining a plurality of multi-channel volumetric image datasets each including multiple different image modality channels. The method also includes assigning each corresponding image modality channel to a dedicated set of one or more of the channel-wise adapter modules. The method also includes executing a parameter-efficient fine-tuning (PEFT) process to train an image analysis model on the plurality of multi-channel volumetric image datasets to teach the image analysis model to learn how to perform a downstream vision task. The image analysis model incorporates the pre-trained image encoder modified by the plurality of channel-wise adapter modules and the PEFT process trains the image analysis model by fine-tuning parameters of the plurality of channel-wise adapter modules.

### CROSS-REFERENCE TO RELATED APPLICATIONS

This U.S. Patent application claims priority under 35 U.S.C. § 119 (e) to U.S. Provisional Application 63/787,171, filed on Apr. 11, 2025. The disclosure of this prior application is considered part of the disclosure of this application and is hereby incorporated by reference in its entirety.

### TECHNICAL FIELD

This disclosure relates to parameter efficient fine-tuning of large vision foundational models for multi-channel medical image segmentation.

### BACKGROUND

Multi-dimensional medical images, such as three-dimensional (3D) medical images, provide enriched images of an interior body of a patient to assist in facilitating medical analysis, diagnosis, or treatment of the patient. Such medical images can be generated using different modalities including, for example, magnetic resonance imaging (MRI), positron emission tomography (PET), or computed tomography (CT).

Vision foundational models, such as Vision Transformers (ViTs), are pre-trained on planar two-dimensional (2D) images with fixed channel structures to learn robust representations. Medical image segmentation tasks increasingly leverage vision foundational models due to their robust learned representation. However, when pre-trained vision foundational models are applied to multi-channel volumetric medical imaging data, such as multi-sequence MRI or PET/CT, image segmentation tasks become challenging since the pre-trained vision foundational models learned their robust representations from planar 2D images with fixed channel structures. Moreover, adapting a pre-trained vision foundational model to ingest multi-channel volumetric medical imaging data typically requires significant architecture modifications and substantially computational resources.

### SUMMARY

One aspect of the disclosure provides a computer-implemented method executing on data processing hardware that causes the data processing hardware to perform operations for or adapting a pre-trained image encoder with channel-wise adapter modules to perform downstream vision tasks on multi-channel volumetric image datasets. The operations include obtaining a pre-trained image encoder and modifying the pre-trained image encoder by incorporating, into the pre-trained image encoder, a plurality of channel-wise adapter modules. The operations also include obtaining a plurality of multi-channel volumetric image datasets each including multiple different image modality channels. Each multi-channel volumetric image dataset includes a plurality of image voxels each paired with a corresponding ground-truth label indicating a class the corresponding image voxel belongs to. For each corresponding image modality channel among the multiple different image modality channels, the operations also include assigning the corresponding image modality channel to a dedicated set of one or more of the channel-wise adapter modules from the plurality of channel-wise adapter modules incorporated into the pre-trained image encoder. The operations also include executing a parameter-efficient fine-tuning (PEFT) process to train an image analysis model on the plurality of multi-channel volumetric image datasets to teach the image analysis model to learn how to perform a downstream vision task on multi-channel volumetric image datasets. The image analysis model incorporates the pre-trained image encoder modified by the plurality of channel-wise adapter modules and the PEFT process trains the image analysis model by fine-tuning parameters of the plurality of channel-wise adapter modules while parameters of the pre-trained image encoder are held fixed.

Implementations of the disclosure may include one or more of the following optional features. In some implementations, the multiple image modality channels of each corresponding multi-channel volumetric image dataset are co-registered. The pre-trained image encoder may include a plurality of multi-head attention layers, assigning the corresponding image modality channel to the dedicated set of the one or more of the channel-wise adapter modules may include assigning the corresponding image modality channel to a corresponding dedicated set of multiple channel-wise adapter modules from the plurality of channel-wise adapter modules incorporated into the pre-trained image encoder, and each channel-wise adapter module in the corresponding dedicated set of multiple channel-wise adapter modules assigned to the corresponding image modality channel may be added to a respective one of the plurality of multi-head attention layers.

In some examples, executing the PEFT process includes, for each corresponding multi-channel volumetric image dataset: for each corresponding image modality channel among the multiple different image modality channels of the corresponding multi-channel volumetric image data set: dividing the corresponding image modality channel into a plurality of image patches; activating each channel-wise adapter module in the dedicated set of the one or more channel-wise adapter modules assigned to the corresponding image modality channel to adapt the pre-trained image encoder for processing the corresponding image modality channel separately from each other image modality channel in the corresponding multi-channel volumetric image dataset; and processing, using the pre-trained encoder and each activated channel-wise adapter module in the dedicated set of the one or more channel-wise adapter modules assigned to the corresponding image modality channel, the image patches divided from the corresponding image modality channel to generate corresponding latent encoded representations for the corresponding image modality channel; concatenating the latent encoded representations separately generated for each of the multiple different image modality channels into a concatenated set of latent encoded representations; processing, using a decoder of the image analysis model, the concatenated set of latent encoded representation to predict a corresponding class for each voxel of the corresponding multi-channel volumetric medical image dataset; determining a training loss for the corresponding multi-channel volumetric image dataset based on the predicted classes for the voxels and the ground-truth labels paired with the voxels; and fine-tuning the parameters of the channel-wise adapter modules based on the training loss while parameters of the pre-trained image encoder remain fixed. In these examples, fine-tuning the parameters of the channel-wise adapter modules may further include updating parameters of the decoder based on the training loss. Additionally, when processing the image patches divided from the corresponding image modality channel to generate the corresponding latent encoded representations for the corresponding image modality channel, each channel-wise adapter module in the dedicated sets of one or more adapter modules assigned to the other image modality channels may be deactivated.

In some implementations, executing the PEFT process includes, for each corresponding multi-channel volumetric image dataset: for each corresponding image modality channel among the multiple different image modality channels of the corresponding multi-channel volumetric image data set: dividing the corresponding image modality channel into a plurality of image patches; activating each channel-wise adapter module in the dedicated set of the one or more channel-wise adapter modules assigned to the corresponding image modality channel to adapt the pre-trained image encoder for processing the corresponding image modality channel separately from each other image modality channel in the corresponding multi-channel volumetric image dataset; and processing, using the pre-trained encoder and each activated channel-wise adapter module in the dedicated set of the one or more channel-wise adapter modules assigned to the corresponding image modality channel, the image patches divided from the corresponding image modality channel to generate corresponding latent encoded representations for the corresponding image modality channel; concatenating the latent encoded representations separately generated for each of the multiple different image modality channels into a concatenated set of latent encoded representations; processing, using a downstream module of the image analysis model, the concatenated set of latent encoded representation to predict a corresponding class for each voxel of the corresponding multi-channel volumetric medical image dataset; determining a training loss for the corresponding multi-channel volumetric image dataset based on the predicted classes for the voxels and the ground-truth labels paired with the voxels; and fine-tuning the parameters of the channel-wise adapter modules based on the training loss while parameters of the pre-trained image encoder remain fixed. In these implementations, fine-tuning the parameters of the channel-wise adapter modules may further include updating parameters of the downstream module based on the training loss. Additionally, the downstream module may include at least one of a decoder or one or more prediction heads.

In some examples, the multiple different image modality channels are associated with a multi-sequence magnetic resonance imaging (MRI) of a target anatomical region obtained by an MRI scanner. Here, the multiple different image modality channels may include two or more of a T1-weighted sequence, a T2-weighted sequence, a T2 Fluid-Attenuated Inversion Recovery (FLAIR) sequence, a Diffusion-Weighted Imaging (DWI) sequence, or a Apparent Diffusion Coefficient (ADC) map. The multiple different modality channels may include a first modality channel associated with positron emission tomography (PET) scan of a target anatomical region and a second modality channel associated with a computed tomography (CT) scan of the same target anatomical region.

Another aspect of the disclosure provides a system that includes data processing hardware and memory hardware storing instructions that when executed on the data processing hardware causes the data processing hardware to perform operations for adapting a pre-trained image encoder with channel-wise adapter modules to perform downstream vision tasks on multi-channel volumetric image datasets. The operations include obtaining a pre-trained image encoder and modifying the pre-trained image encoder by incorporating, into the pre-trained image encoder, a plurality of channel-wise adapter modules. The operations also include obtaining a plurality of multi-channel volumetric image datasets each including multiple different image modality channels. Each multi-channel volumetric image dataset includes a plurality of image voxels each paired with a corresponding ground-truth label indicating a class the corresponding image voxel belongs to. For each corresponding image modality channel among the multiple different image modality channels, the operations also include assigning the corresponding image modality channel to a dedicated set of one or more of the channel-wise adapter modules from the plurality of channel-wise adapter modules incorporated into the pre-trained image encoder. The operations also include executing a parameter-efficient fine-tuning (PEFT) process to train an image analysis model on the plurality of multi-channel volumetric image datasets to teach the image analysis model to learn how to perform a downstream vision task on multi-channel volumetric image datasets. The image analysis model incorporates the pre-trained image encoder modified by the plurality of channel-wise adapter modules and the PEFT process trains the image analysis model by fine-tuning parameters of the plurality of channel-wise adapter modules while parameters of the pre-trained image encoder are held fixed.

This aspect of the disclosure may include one or more of the following optional features. In some implementations, the multiple image modality channels of each corresponding multi-channel volumetric image dataset are co-registered. The pre-trained image encoder may include a plurality of multi-head attention layers, assigning the corresponding image modality channel to the dedicated set of the one or more of the channel-wise adapter modules may include assigning the corresponding image modality channel to a corresponding dedicated set of multiple channel-wise adapter modules from the plurality of channel-wise adapter modules incorporated into the pre-trained image encoder, and each channel-wise adapter module in the corresponding dedicated set of multiple channel-wise adapter modules assigned to the corresponding image modality channel may be added to a respective one of the plurality of multi-head attention layers.

In some examples, executing the PEFT process includes, for each corresponding multi-channel volumetric image dataset: for each corresponding image modality channel among the multiple different image modality channels of the corresponding multi-channel volumetric image data set: dividing the corresponding image modality channel into a plurality of image patches; activating each channel-wise adapter module in the dedicated set of the one or more channel-wise adapter modules assigned to the corresponding image modality channel to adapt the pre-trained image encoder for processing the corresponding image modality channel separately from each other image modality channel in the corresponding multi-channel volumetric image dataset; and processing, using the pre-trained encoder and each activated channel-wise adapter module in the dedicated set of the one or more channel-wise adapter modules assigned to the corresponding image modality channel, the image patches divided from the corresponding image modality channel to generate corresponding latent encoded representations for the corresponding image modality channel; concatenating the latent encoded representations separately generated for each of the multiple different image modality channels into a concatenated set of latent encoded representations; processing, using a decoder of the image analysis model, the concatenated set of latent encoded representation to predict a corresponding class for each voxel of the corresponding multi-channel volumetric medical image dataset; determining a training loss for the corresponding multi-channel volumetric image dataset based on the predicted classes for the voxels and the ground-truth labels paired with the voxels; and fine-tuning the parameters of the channel-wise adapter modules based on the training loss while parameters of the pre-trained image encoder remain fixed. In these examples, fine-tuning the parameters of the channel-wise adapter modules may further include updating parameters of the decoder based on the training loss. Additionally, when processing the image patches divided from the corresponding image modality channel to generate the corresponding latent encoded representations for the corresponding image modality channel, each channel-wise adapter module in the dedicated sets of one or more adapter modules assigned to the other image modality channels may be deactivated.

In some implementations, executing the PEFT process includes, for each corresponding multi-channel volumetric image dataset: for each corresponding image modality channel among the multiple different image modality channels of the corresponding multi-channel volumetric image data set: dividing the corresponding image modality channel into a plurality of image patches; activating each channel-wise adapter module in the dedicated set of the one or more channel-wise adapter modules assigned to the corresponding image modality channel to adapt the pre-trained image encoder for processing the corresponding image modality channel separately from each other image modality channel in the corresponding multi-channel volumetric image dataset; and processing, using the pre-trained encoder and each activated channel-wise adapter module in the dedicated set of the one or more channel-wise adapter modules assigned to the corresponding image modality channel, the image patches divided from the corresponding image modality channel to generate corresponding latent encoded representations for the corresponding image modality channel; concatenating the latent encoded representations separately generated for each of the multiple different image modality channels into a concatenated set of latent encoded representations; processing, using a downstream module of the image analysis model, the concatenated set of latent encoded representation to predict a corresponding class for each voxel of the corresponding multi-channel volumetric medical image dataset; determining a training loss for the corresponding multi-channel volumetric image dataset based on the predicted classes for the voxels and the ground-truth labels paired with the voxels; and fine-tuning the parameters of the channel-wise adapter modules based on the training loss while parameters of the pre-trained image encoder remain fixed. In these implementations, fine-tuning the parameters of the channel-wise adapter modules may further include updating parameters of the downstream module based on the training loss. Additionally, the downstream module may include at least one of a decoder or one or more prediction heads.

In some examples, the multiple different image modality channels are associated with a multi-sequence magnetic resonance imaging (MRI) of a target anatomical region obtained by an MRI scanner. Here, the multiple different image modality channels may include two or more of a T1-weighted sequence, a T2-weighted sequence, a T2 Fluid-Attenuated Inversion Recovery (FLAIR) sequence, a Diffusion-Weighted Imaging (DWI) sequence, or a Apparent Diffusion Coefficient (ADC) map. The multiple different modality channels may include a first modality channel associated with positron emission tomography (PET) scan of a target anatomical region and a second modality channel associated with a computed tomography (CT) scan of the same target anatomical region.

In yet another aspect of the present disclosure provides a computer-implemented method executing on data processing hardware that causes the data processing hardware to perform operations that include receiving a multi-channel volumetric image dataset including multiple different image modality channels. Each image modality channel of the multiple different image modality channels is assigned to a dedicated set of one or more channel-wise adapter modules incorporated into a pre-trained image encoder. For each corresponding image modality channel of the multiple image modality channels, the operations also include dividing the corresponding image modality channel into a plurality of image patches, activating each channel-wise adapter module in the dedicated set of the one or more channel-wise adapter modules assigned to the corresponding image modality channel to adapt the pre-trained image encoder for processing the corresponding image modality channel separately from each other image modality channel in the corresponding multi-channel volumetric image dataset, and processing, using the pre-trained encoder and each activated channel-wise adapter module in the dedicated set of the one or more channel-wise adapter modules assigned to the corresponding image modality channel. The image patches is divided from the corresponding image modality channel to generate corresponding latent encoded representations for the corresponding image modality channel. The operations also include concatenating the latent encoded representations separately generated for each of the multiple different image modality channels into a concatenated set of latent encoded representations, and processing, using a task-specific downstream module of the image analysis model, the concatenated set of latent encoded representations to generate an enhanced volumetric image.

This aspect of the disclosure may include one or more of the following optional features. In some implementations, processing, using the task-specific downstream module of the image analysis module, the concatenated set of latent encoded representations further includes processing the concatenated set of latent encoded representations to predict a corresponding class for each voxel of the enhanced volumetric image to classify one or more target objects. In these implementations, processing, using the task-specific downstream module of the image analysis model, the concatenated set of latent encoded representations may further include processing the concatenated set of latent encoded representations to separate each of the one or more target objects from one another by defining a respective segmentation mask to overly on the voxels classifying each target object.

Another aspect of the disclosure provides a system that includes data processing hardware and memory hardware storing instructions that when executed on the data processing hardware causes the data processing hardware to perform operations that include receiving a multi-channel volumetric image dataset including multiple different image modality channels. Each image modality channel of the multiple different image modality channels is assigned to a dedicated set of one or more channel-wise adapter modules incorporated into a pre-trained image encoder. For each corresponding image modality channel of the multiple image modality channels, the operations also include dividing the corresponding image modality channel into a plurality of image patches, activating each channel-wise adapter module in the dedicated set of the one or more channel-wise adapter modules assigned to the corresponding image modality channel to adapt the pre-trained image encoder for processing the corresponding image modality channel separately from each other image modality channel in the corresponding multi-channel volumetric image dataset, and processing, using the pre-trained encoder and each activated channel-wise adapter module in the dedicated set of the one or more channel-wise adapter modules assigned to the corresponding image modality channel. The image patches is divided from the corresponding image modality channel to generate corresponding latent encoded representations for the corresponding image modality channel. The operations also include concatenating the latent encoded representations separately generated for each of the multiple different image modality channels into a concatenated set of latent encoded representations, and processing, using a task-specific downstream module of the image analysis model, the concatenated set of latent encoded representations to generate an enhanced volumetric image.

This aspect of the disclosure may include one or more of the following optional features. In some implementations, processing, using the task-specific downstream module of the image analysis module, the concatenated set of latent encoded representations further includes processing the concatenated set of latent encoded representations to predict a corresponding class for each voxel of the enhanced volumetric image to classify one or more target objects. In these implementations, processing, using the task-specific downstream module of the image analysis model, the concatenated set of latent encoded representations may further include processing the concatenated set of latent encoded representations to separate each of the one or more target objects from one another by defining a respective segmentation mask to overly on the voxels classifying each target object.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is schematic view of a system for adapting a pre-trained image encoder with channel-wise adapter modules to perform downstream vision tasks on multi-channel volumetric image datasets.

FIGS. 2A and 2B is a schematic view of example self-supervised training processes for pre-training the image encoder of FIG. 1.

FIG. 3 is a schematic view of an example image analysis model incorporating the pre-trained image encoder adapted by the channel-wise adapter modules and a decoder.

FIGS. 4A and 4B are tables depicting a comparison of performance and parameter count for four different image analysis model configurations.

FIG. 5 is a flowchart of an example arrangement of operations for a method of using a parameter-efficient fine-tuning (PEFT) process to train an image analysis model to learn how to perform a downstream vision task on multi-channel volumetric image datasets.

FIG. 6 is a schematic view of an example computing device that may be used to implement the systems and methods described herein.

Like reference symbols in the various drawings indicate like elements.

### DETAILED DESCRIPTION

Three-dimensional (3D) medical imaging technologies such as magnetic resonance imaging (MRI), positron emission tomography (PET), and computed tomography (CT) are widely used in diagnosing and treating a wide range of diseases. Generally, 3D medical volumetric images can help increase the speed and accuracy of diagnosing patient conditions. For instance, properly and swiftly discovering and measuring tumor lesions from MRI, PET, and/or CT scans could be critical to disease prevention, early detection and treatment plan optimization, and also inspire the development of more successful clinical applications to ultimately improve patients' lives. A fundamental task performed for medical image analysis includes 3D image segmentation. Another fundamental task performed for medical image analysis includes image classification. Image classifications tasks classify input images into various categories. Generally, 3D image segmentation (also referred to as ‘3D semantic segmentation’) aims to predict a corresponding class for each voxel of a volumetric input image to classify one or more particular objects and separating each of the particular objects from one another by overlying respective segmentation masks over the particular objects. 3D image segmentation has the potential to alleviate the burden for radiologists' daily workload by automating or assisting image interpretation workflow to ultimately improve clinical care and patient outcome. Example 3D image segmentation tasks may include brain tumor segmentation performed as a three-class segmentation task with four-channel input and prostate segmentation performed as a two-class segmentation task with two-channel input. Other fundamental tasks performed for medical image analysis include clinical endpoint prediction; detection and localization tasks; registration/alignment; image reconstruction, enhancement, and/or synthesis; and multi-task learning.

Self-supervised learning is a training technique that focuses on learning representations from unlabeled data so that a low-capacity classifier can achieve high accuracy using various embeddings. Contrastive learning is another example of self-supervised learning strategies. Contrastive learning models image similarity and dissimilarity (or solely similarity) between two or more views, with data augmentation being crucial for contrastive and related approaches. Self-supervised learning can be used in the medical field such as in domain-specific pretext tasks or tailoring contrastive learning to medical data. A range of self-supervised learning strategies can be applied to 3D medical imaging. For example, a model pretrained on the ImageNet dataset can be applied to dermatology image classification. In another example, inpainting can be combined with contrastive learning for medical image segmentation.

Masked image modeling (MIM) approaches, in general, mask out a portion of input images or encoded image tokens and encourage the model to recreate the masked area. Some extant MIM models employ an encoder-decoder design followed by a projection head. The encoder aids in the modeling of latent feature representations, while the decoder aids in the resampling of latent vectors to original images. The encoded or decoded embeddings can subsequently be aligned with the original signals at the masked area by a projection head. Notably, the decoder component can be a lightweight design so as to minimize training time. A lightweight decoder can not only reduce computing complexity but also can increase the encoder's ability to learn more generalizable representations that the decoder can easily grasp, translate, and convey. Encoding techniques such as SimMIM can obviate the entire decoder with a single projection layer. The encoder is pre-trained using MIM to learn robust representations.

Using a vision transformer (ViT), for example, an image can be divided into regular non-overlapping patches (e.g., a 96×96×96 3D volume can be divided into 216 patches of 16×16×16 smaller volumes), which are often considered as the basic processing units of vision transformers. There are a number of random masking techniques, including but not limited to, a central region masking strategy, a complex block-wise masking strategy, and/or a uniformly random masking method at patch level using different masked patch sizes and masking ratios.

In some examples, the image encoder includes a vision transformer (ViT) architecture such as vanilla ViT (e.g., ViT3D, Swin-Transformer 3D, and/or an attention visual network (e.g., VAN3D) that can inherit an attention mechanism to derive hierarchical representations similar to, for example, Swin-Transformer 3D but instead using pure convolutions. Other types of multi-head attention layers may be employed by the image encoder such as, without limitation, Conformer layers, Performer layers, or lightweight convolutional layers.

Vision foundational models, such as Vision Transformers (ViTs), are pre-trained on planar two-dimensional (2D) images with fixed channel structures using self-supervised training techniques to teach the vision foundational model (e.g., vision encoder) to learn robust representations. Medical image analysis tasks increasingly leverage vision foundational models due to their robust learned representation. However, when pre-trained vision foundational models are applied to multi-channel volumetric medical imaging data, such as multi-sequence MRI or PET/CT, image analysis tasks, such as image segmentation, become challenging since the pre-trained vision foundational models learned their robust representations from planar 2D images with fixed channel structures. Moreover, adapting a pre-trained vision foundational model to ingest multi-channel volumetric medical imaging data typically requires significant architecture modifications and substantially computational resources.

A multi-channel volumetric imaging data set indicates that for each image voxel (i.e., spatial location) of a same anatomical region, there are multiple different measurements or types/modalities of image information. Here, a multi-channel volumetric imaging data set includes multiple imaging modality channels where each “imaging modality channel” represents a distinct modality or contrast mechanism that provides complementary information about the same anatomical region that may be different than the complementary information represented by each other imaging modality channel in the multi-channel volumetric imaging data set about the same anatomical region. Each of the multiple imaging modality channels are typically acquired simultaneously, sequentially in a same scanning session, or even using different machines followed by image registration to co-register the image voxels across the channels.

For multi-sequence MRI, an MRI scanner may run different pulse sequences during a single example of a target anatomical region of a subject. Each sequence run by the MRI scanner manipulates magnetic fields and radio waves differently to highlight specific tissue properties. Each sequence in the multi-sequence MRI is associated with a respective imaging modality channel. Common sequences associated with multi-sequence MRI include, without limitation, T1-weighted (good for visualizing anatomy where fat appears bright), T2-weighted (good for visualizing pathology/water content where fluid appears bright), T2 Fluid-Attenuated Inversion Recovery (FLAIR) (similar to T2-weighted but suppresses signals from cerebrospinal fluid so that lesions near fluid spaces are more conspicuous), and Diffusion-Weighted Imaging (DWI) (good for measuring the diffusion of water molecules for increased sensitivity of cellular changes such as stroke or dense tumors). Additionally, an Apparent Diffusion Coefficient (ADC) map can be derived from a DWI sequence and the resulting ADC map may be associated with a respective channel. All the channels representing a multi-sequence MRI are inherently co-registered since they are typically acquired at a same position (e.g., anatomical region) of a position using the same MRI scanner.

A PET/CT scan provides a hybrid technique that combines two different imaging modalities, e.g., a first imaging modality associated with a PET scan of a target anatomical region of a subject, and a second imaging modality associated with a CT scan of the same target anatomical region of the subject. The PET imaging modality provides functional/metabolic information based on a PET scanner detecting concentration of a radioactive tracer injected at the target anatomical region. The PET imaging modality may indicate areas of high metabolic activity, such as the presence of tumors or inflammation. The CT imaging modality provides detailed anatomical/structural information derived from X-rays to reveal bone, soft tissues and organ outlines. Accordingly, in a PET/CT scan, the target anatomical region of the subject is scanned using both the PET imaging modality and the CT imaging modality resulting in respective datasets that are fused, co-registered, and spatially aligned. Here, the PET imaging modality forms a first imaging modality channel depicting the functional/metabolic information at the target anatomical region while the CT imaging modality forms a second imaging modality channel depicting the anatomical/structural information at the target anatomical region. Thus, each corresponding image voxel in the PET/CT scan provides a first value, representing the functional/metabolic activity at the spatial location of the target anatomical region associated with the corresponding image voxel, and a second value, representing the attenuation/tissue density at the spatial location of the target anatomical region associated with the corresponding image voxel.

Implementations herein are directed toward integrating a pre-trained vision encoder into an image analysis model and executing a parameter-efficient fine-tuning (PEFT) process to train the image analysis model on a plurality of annotated multi-channel volumetric medical image datasets by updating/fine-tuning adapter modules added to the pre-trained vision encoder while parameters of the pre-trained vision encoder are held fixed. In some examples, the image analysis model includes the pre-trained image encoder modified by the trainable adapter modules and one or more task-specific downstream modules. For instance, a task-specific downstream module may include a decoder, such as a convolutional neural network (CNN) decoder. In addition to or in lieu of the decoder, the image analysis model may instead implement one or more prediction heads as task-specific downstream modules. Specifically, the image analysis model may include a U-Net Transformer (UNETR) architecture augmented by the adapter modules to enable the UNETR architecture to perform image analysis tasks on multi-channel volumetric medical image datasets. For instance, the image analysis tasks may include image segmentation and/or image classification. Here, each respective imaging modality channel from the multi-channel medical image datasets is assigned to a dedicated channel-wise adapter module incorporated into the pre-trained vision encoder such that the dedicated channel-wise adapter module is activated when the respective imaging modality is provided as input to the UNETR architecture during training. The UNETR may implement a dynamic adapter-switching mechanism to alternate between activating the channel-wise adapter modules to facilitate efficient adaptation to the specific characteristics of the respective imaging modality channel without requiring retraining of the parameters of the pre-trained vision encoder. Using the dedicated channel-specific adaptor modules, the pre-trained encoder is configured to generate latent encoded representations for each respective imaging modality channel and the latent encoded representations generated for all the different imaging modality channels of each corresponding multi-channel volumetric medical image dataset are concatenated and the concatenated latent encoded representations are processed by the CNN decoder (or prediction head) to predict a corresponding segmentation class for each voxel in the multi-channel volumetric medical image dataset. Classification tasks performed by the image analysis model may include disease sybstype classifications, disease stage, pathology presence or absence to name a few. A loss module may determine a loss based on the predicted segmentation classes for the voxels and ground-truth labels indicating the class that each voxel belongs to. Thereafter, the PEFT process trains the image analysis model having the UNETR architecture by updating/fine-tuning the dedicated channel-wise adapter modules incorporated into the pre-trained vision encoder and updating parameters of the CNN decoder based on the loss while parameters of the pre-trained vision encoder are held fixed or frozen.

The image analysis model may be trained on multi-channel medical image datasets to perform image analysis tasks other than image segmentation or image classification. In some examples, the image analysis task includes clinical endpoint prediction. Here, the pre-trained image encoder modified by the trainable adapter modules may implement multiple task-specific downstream modules each configured to generate a different output. These outputs may include, without limitation, treatment response prediction, survival/prognosis, prediction, recurrence risk, progression prediction, toxicity/adverse event prediction, biomarker prediction, responder stratification, and longitudinal outcome prediction. In some additional examples, the image analysis model is trained to perform image detection localization tasks such as lesion detection, landmark localization, bounding box placement, and/or keypoint detection. In yet further examples, the image analysis model is trained to perform registration/alignment tasks such as cross-modality alignment or longitudinal alignment. The image analysis model may additionally be trained on multi-channel medical image datasets to synthesize new images, reconstruct input image data, and/or enhance input image. For instance, the image analysis model can be trained to perform various tasks such as denoising, super-resolution, modality synthesis, missing-modality reconstruction, and/or harmonization.

For the task of image segmentation, after the PEFT process trains the image analysis model by updating the parameters of the decoder (or prediction head) and updating/fine-tuning the dedicated channel-wise adapter modules incorporated into the pre-trained vision encoder, the trained image analysis model may perform image segmentation on a raw multi-channel volumetric medical image data set by generating latent encoded representations for each respective imaging modality channel using the dedicated channel-wise adapter module assigned to the respective imaging modality channel, concatenating the latent encoded representations generated for all the imaging modality channels, and processing, by the decoder (or prediction head), the concatenated latent encoded representations to generate an enhanced output image that includes predicted segmentation values for each voxel from the medical image data set. In some implementations, the PEFT process includes a multi-task learning process for updating/fine-tuning different dedicated channel-wise adapter modules incorporated into the pre-trained vision encoder to support multiple task-specific outputs such as, without limitation, any combination of segmentation, prognosis or detection, classification, detection/localization, registration/alignment, or image reconstruction/enhancement/synthesis.

In some examples, the image encoder includes a plurality of multi-head attention blocks (interchangeably referred to as “multi-head attention layers”) and each channel-wise adapter module includes a Low-Rank Adaptation (LoRA) adapter having two low-rank projection matrices added to each multi-head attention block. That is, for each corresponding imaging modality channel in a multi-channel medical image data set, a dedicated LoRA adapter having two low-rank projection matrices is added to each of the plurality of multi-head attention blocks to teach the vision encoder to learn how to generate latent encoded representations for the corresponding imaging modality channel. While examples herein disclose using LoRA adapters as PEFT technique for the vision encoder, the pre-trained vision encoder may be finetuned using other PEFT techniques without departing from the scope of the present disclosure, such as adapters, residual adapters, or other sub-models having trainable parameters for adapting the pertained vision encoder to the modality-specific characteristics associated with each imaging modality channel without retraining any of the parameters of the pre-trained vision encoder.

Described in greater detail below, the trained image analysis model may receive, as input, multiple sets of multiple image patches each divided from a respective imaging modality channel in a multi-channel volumetric medical image data set (i.e., a volumetric slice from a MRI or CT scan), generate an enhanced medical image based on a concatenation of latent encoded representations extracted from each imaging modality channel in the multi-channel volumetric medical image data set, and perform image segmentation or image classification on the enhanced image. In the image segmentation scenario, the trained image analysis model may be trained to classify one or more particular objects (e.g., tumors or organs) in the enhanced image and separating each of the particular objects from one another by augmenting the enhanced image to include respective segmentation masks overlaying the particular objects. As used herein, augmenting an enhanced image to include a segmentation mask includes augmenting image voxels in the enhanced image that represent each object class and/or define a boundary of the respective object class. The augmenting of image voxels may include changing a color of the image voxels, adjusting an intensity of the image voxels, or augmenting the image voxels in any suitable manner so that each object classified is distinguishable and identifiable within the enhanced image.

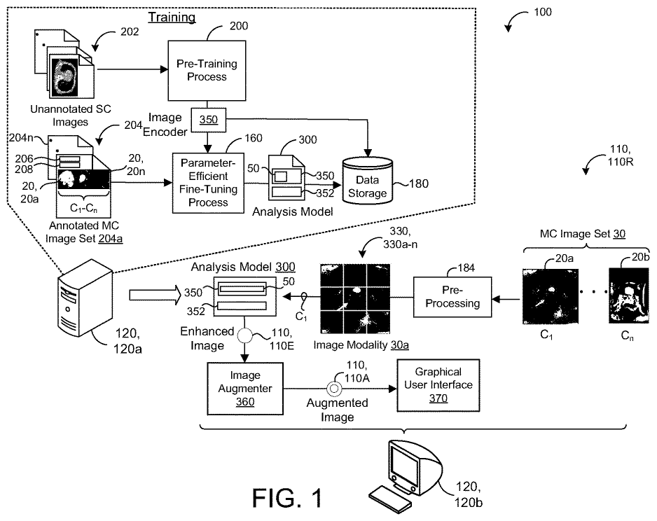

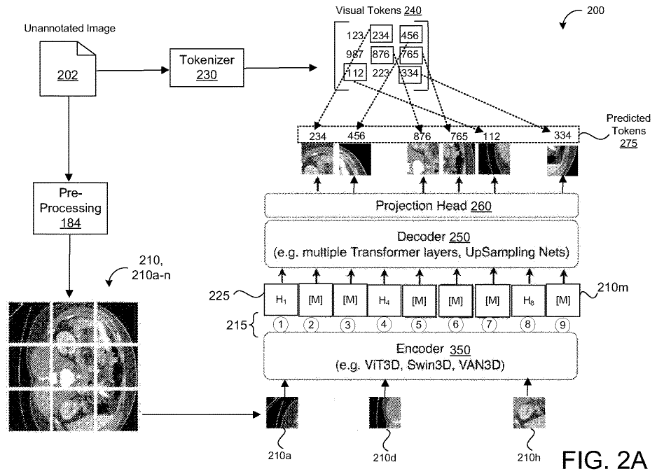

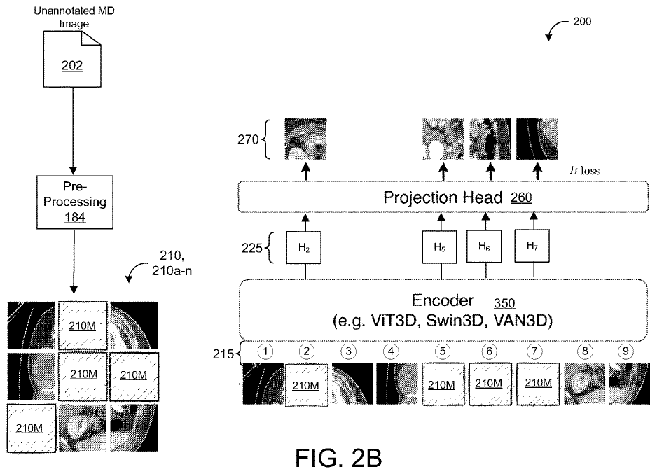

FIG. 1 shows an example system 100 for pre-training an image encoder 350 via a self-supervised training process 200 to learn how to generate latent encoded representations 225 (FIGS. 2A and 2B) from unannotated medical images 201 and adapting the pre-trained encoder 350 to perform a downstream image task on a plurality of multi-channel volumetric medical image data sets 204, 204a-n via a parameter-efficient fine-tuning (PEFT) process 160. Specifically, channel-wise adapter modules 50 are added to the pre-trained image encoder 350 and the PEFT process 160 adapts the pre-trained image encoder 350 for use in an image analysis model 300 by updating or fine-tuning parameters of the channel-wise adapter modules 50 and updating parameters of a downstream module 352 of the image analysis model 300 while parameters of the pre-trained image encoder 350 are held fixed.

The downstream module 352 may include a decoder or a prediction head. The decoder 352 may include a segmentation decoder (e.g., CNN decoder) implemented in a U-Net Transformer (UNETR) or UNETR-style model architecture The prediction head 352 could include a classification head implementing pooling and multi-perceptron (MLP). The prediction head 352 may include regression heads implemented for endpoint prediction, detection heads, localization heads, or registration heads. In some examples, the downstream module 352 includes a reconstruction/generative decoder. The downstream module 352 may include multi-branch heads for use in multi-task learning.

The system 100 includes a computing system 120 having data processing hardware 1510 (FIG. 7) and memory hardware 1520 (FIG. 7) in communication with the data processing hardware 1510 and storing instructions that cause the data processing hardware 1510 to perform operations. In some implementations, a first computing system 120, 120a executes the self-supervised training process 200 to pre-train the image encoder 150 and then executes the PEFT process 160 to train the image analysis model 300 incorporating the pre-trained image encoder 150 modified by the channel-wise adapter modules to perform the downstream vision task on 3D multi-channel medical image data sets. In these implementations, after the image analysis model 300 is trained to perform the downstream vision task, the first computing system 120a may provide the trained image analysis model 300 to a second computing system 120, 120b. Here, the second computing system 120b may execute the image analysis model 300 to generate an enhanced volumetric (e.g., three-dimensional) medical images 110 from a raw multi-channel volumetric medical image datasets 30 and perform the downstream vision task on the enhanced volumetric medical image 110.

The first computing system 120a may include a distributed system (e.g., cloud computing environment). The second computing system 120b may include a computing device (e.g., desktop computer, workstation, laptop, tablet, etc.) that downloads the image analysis model 300 from the first computing system 120a. In some other implementations, the first computing system 120a receives the raw multi-channel volumetric medical image dataset 30 from the second computing system 120b and executes the image analysis model 300 to perform the downstream vision task. In additional implementations, the second computing system 120b receives, from the first computing system 120a, the image encoder 350 pre-trained by the self-supervised training process 200 and executes the PEFT process 160 to adapt the pre-trained image encoder 350 for the downstream vision task by updating parameters of the channel-wise adapter modules 50 added to the pre-trained image encoder 350 as well as updating parameters of the CNN decoder 352. In this scenario, the plurality of multi-channel volumetric medical image datasets 204 may be processed locally on the second computing system 120b via the PEFT process 160, thereby preserving privacy and sensitive data.

The self-supervised training process 200 trains the image encoder 350 on the plurality of unannotated single-channel images 202. The single-channel images 202 can include single-channel medical images, single-channel images not in the medical domain, or a combination thereof. The self-supervised training process 200 is not limited to any specific self-supervised technique. However, as described in greater detail below with reference to FIGS. 2A and 2B, the self-supervised training process may include a masked auto-encoder (MAE) training process (FIG. 2A) or a self-supervised masked image modeling (MIM) training process (FIG. 2B).

Notably, self-supervised MAE and MIM training as disclosed herein is especially advantageous for modeling volumetric images by significantly speeding up training convergence and improves downstream performance. For instance, when compared to naive contrastive learning, training convergence can save up to a 1.40×training cost to reach a same or higher dice score when the pre-trained image encoder 150 is adapted and fine-tuned to perform a downstream vision task. Similarly, the downstream performance of the downstream vision task of image segmentation can achieve over 5-percent (5%) improvements without any hyper parameter tuning. Additionally, downstream applications incorporating the image encoder pre-trained via self-supervised training are faster and more cost-effective then transfer learning to the particular downstream task for prognosis, treatment sensitivity prediction, tissue segmentation, image classification, and digital representations of patients. As will become apparent, pre-training the image encoder 350 via the self-supervised training process 200 enables prediction of raw voxel values using a high masking ratio and a relatively small patch size.

Generally, the pre-training process 200 for pre-training the image encoder 350 includes a learning task that includes masking a subset of input signals (e.g., image patches 210 (FIGS. 2A and 2B)) and forecasting the masked signals. Stated differently, MIM learning/training is a self-supervised learning technique that learns representations via masking-corrupted images. Masking can be presented as a noise type. Masked patch prediction for self-supervised learning can predict missing voxels by inpainting a large rectangular area of the source areas and grouping voxel values into different clusters to classify unknown voxel values. Additionally, masked patch prediction for self-supervised learning can be accomplished by predicting a mean color of images.

After the image encoder 350 is pre-trained via the self-supervised training process 200, the PEFT process 160 trains the image analysis model 300 on the plurality of multi-channel volumetric medical image datasets 204, 204a-n by adapting the pre-trained image encoder 350 integrated with the image analysis model 300 to perform downstream vision tasks such as image segmentation tasks or image classification tasks. As described above, the PEFT process 160 may adapt the pre-trained image encoder 350 integrated with the image analysis model 300 to perform other downstream vision tasks such as, without limitation, endpoint prediction tasks, detection/localization tasks, image registration/alignment tasks, image reconstruction/enhancement/synthesis tasks, or multi-task learning. Each multi-channel volumetric medical image dataset 204 includes multiple different image modality channels 20, 20a-n each depicting a same target anatomical region of a subject captured by a scanning device. The terms ‘image modality channel” and imaging modality channel” may be used interchangeably. Each image modality channel 20 in a corresponding multi-channel volumetric medical image dataset 204 includes a plurality of image voxels 206 each paired with a corresponding ground-truth label 208 indicating a class the corresponding image voxel 208 belongs to. All the imaging modality channels 20 representing a corresponding multi-channel volumetric medical image dataset 204 are inherently co-registered since they are typically acquired at a same position (e.g., anatomical region) using a same scanning device. Notably, the unannotated single-channel images 202 used by the pre-training process 200 to pre-train the image encoder 350 may be associated with one or more different domains than the multi-channel volumetric medical image datasets 204. For instance, the multi-channel volumetric medical image datasets 204 may include multi-sequence MRI scans of brain tumors and/or prostrate glands while the single-channel images 202 may include any type of natural image that may or may not include anatomical images.

In one example, the plurality of multi-channel volumetric medical image datasets 204 includes annotated 3D MRI scan images obtained from the Brain Tumor Segmentation (BraTS) public dataset that includes 750 multi-sequence and multi-site MRI scans from patients diagnosed with glioblastoma or lower-grade glioma. Each multi-channel volumetric medical image dataset 204 obtained from the BraTS public data set includes multiple different image modality channels 20, 20a-n each associated with respective ones of native T1-weighted (T1), post-Gadolinium T1-weighted (T1-GD), T2-weighted (T2), and T2 FLAIR sequences acquired by diverse MRI scanners. The scans associated with the multiple image modality channels 20 are co-registered, skull-stripped, and resampled to 1×1×1 millimeter (mm) resolution with ground-truth masks (i.e., indicated by the ground-truth labels 208 of the image voxels 206) derived for whole tumor (WT), tumor core (TC), and enhanced tumor (EC).

In another example, the plurality of multi-channel volumetric medical image datasets 204 include annotated 3D MRI scan images obtained from the ProstateX public dataset that includes 48 multi-parametric MRI scans of anatomical zones of a prostate from patients diagnosed with prostrate cancer. Each multi-channel volumetric medical image dataset 204 obtained from the ProstrateX public data set includes multiple different image modality channels 20, 20a-n each associated with respective ones of a transverse T2-weighted sequence with a resolution of 0.6×0.6×4 mm and a corresponding apparent diffusion coefficient (ADC) map at 2×2×4 mm resolution with ground-truth masks (i.e., indicated by the ground-truth labels 208 of the image voxels 206) for segmenting peripheral zone (PZ) and transition zone (TZ) of the prostate.

In additional examples, the plurality of multi-channel volumetric medical image datasets 204 depict multi-channel MRI scans and/or hybrid CT/PET scans of different anatomical regions than the BraTS and Prostate X public datasets. For instance, a multi-channel volumetric medical image dataset 204 associated with the CT/PET scan includes scanning a target anatomical region of a subject using both the PET imaging modality and the CT imaging modality resulting in respective datasets that are fused, co-registered, and spatially aligned. Here, the PET imaging modality forms a first imaging modality channel 20a at the target anatomical region while the CT imaging modality forms a second imaging modality channel 20b with ground-truth masks (i.e., indicated by the ground-truth labels 208 of the image voxels 206) for segmenting target features/areas/zones or other characteristics within the target anatomical region.

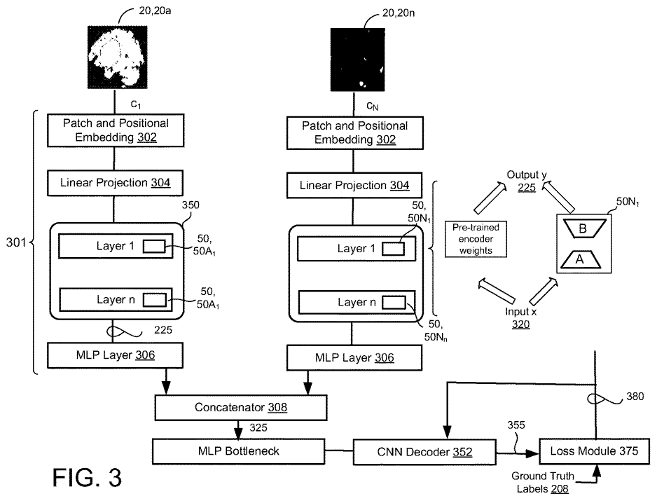

Referring to FIGS. 1 and 3, in some implementations, the image analysis model 300 includes the pre-trained image encoder 350 modified by the trainable adapter modules 50 and a convolutional neural network (CNN) decoder 352 (i.e., downstream module). Specifically, the image analysis model 300 may include a U-Net Transformer (UNETR) architecture augmented by the adapter modules 50 to enable the UNETR architecture to perform image segmentation and/or image classification (and/or other downstream vision tasks mentioned above) on multi-channel volumetric medical image dataset. During the PEFT process 160, each respective imaging modality channel 20a-n from a corresponding multi-channel medical image dataset 204 is assigned to a dedicated set of one or more channel-wise adapter modules 50A-N incorporated into the pre-trained image encoder 350 such that the dedicated set of the one or more channel-wise adapter modules 50A-N is activated when the respective imaging modality channel 20a-n is provided as input to the UNETR architecture during the PEFT process 160. For instance, a first image modality channel 20a (denoted by channel indicator c₁) associated with a T2-weighted MRI sequence may be assigned to a set of dedicated channel-wise adapter modules 50A₁-Aₙ (FIG. 3) each added to a respective one of a plurality of multi-head attention layers (e.g., Layers 1-n) (FIG. 3) of the pre-trained image encoder 350 to teach each dedicated channel-wise adapter module 50A assigned to the first image modality channel 20a to learn how to generate latent representations 225 as output from the pre-trained image encoder 350 for the T2-weightec MRI sequence. In some examples, the channel indicator c₁ associated with the first image modality channel 20a is input to the image analysis model 300 to cause a dynamic adapter-switching mechanism to activate the dedicated set of channel-wise adapter modules 50A₁-Aₙ for fine-tuning/updating parameters of the channel-wise adapter modules 50A₁-Aₙ assigned to the first image modality channel 20a. In these examples, when the channel indicator c1 is provided as input, the dynamic adapter-switching mechanism may deactivate each other dedicated set of channel-wise adapter modules that are assigned to the other image modality channels. As described in greater detail below with reference to FIG. 3, the dynamic adapter-switching mechanism enables the PEFT 160 to modify the pre-trained image encoder 350 by training/fine-tuning the dedicated channel-wise adapter modules 50 separately on a dynamic basis based on the corresponding imaging modality channel of the multi-channel volumetric medical image dataset 204 provided as input. As such, the PEFT process 160 allows the resulting trained image analysis model 300 to reuse the multi-head attention layers from the pre-trained image analysis model as a frozen backbone to enable modality-aware specialization when performing a downstream vision task on a raw multi-channel volumetric medical dataset 30 (FIG. 1) during inference without requiring full fine-tuning of the pre-trained image encoder 350. Accordingly, the PEFT process 160 is effective for improving the ability of the image analysis model 300 perform downstream vision tasks on multi-channel volumetric medical image datasets with heterogenous channels/modalities as well as those with missing modalities.

As shown in FIG. 3, the image analysis model 300 having the UNETR architecture includes a respective encoding branch 301 for adapting the pre-trained image encoder 350 to generate corresponding latent encoded representations 225 for each corresponding image modality channel 20 of each multi-channel volumetric medical image dataset 204 separately. For instance, the encoding branch 301 processes the first image modality channel 20a by activating the dedicated set of channel-wise adapter modules 50A₁-Aₙ assigned to the first image modality channel 20a to adapt the pre-trained image encoder 350 to generate corresponding latent encoded representations 225 for the first image modality channel 20a. Separately, the encoding branch 301 processes the second image modality channel 20b by activating the dedicated set of channel-wise adapter modules 50B₁-Bₙ assigned to the second image modality channel 20b to adapt the pre-trained image encoder 350 to generate corresponding latent encoded representations 225 for the second image modality channel 20b. For each additional respective image modality channel 20n of the same multi-channel volumetric medical image data set 204, the encoding branch 301 separately processes the respective image modality channel 20n by activating the dedicated set of channel-wise adapter modules 50N₁-Nₙ assigned to the respective image modality channel 20n to adapt the pre-trained image encoder 350 to generate corresponding latent encoded representations 225 for the respective image modality channel 20n.

Each encoding branch 301 includes a patch and positional embedding layer 302 that pre-processes each corresponding image modality channel 20 of a corresponding multi-channel volumetric image dataset 104 by dividing the corresponding image modality channel 20 into a plurality of patches 330 and assigning positional embeddings to the plurality of patches 330. The plurality of patches 330 with assigned positional embeddings pass through a linear projection layer 304 before input to the pre-trained image encoder 350 having the plurality of multi-head attention layers (Layers 1-N). In some examples, the pre-trained image encoder 350 includes twelve multi-head attention layers. While examples herein depict the multi-head attention layers or blocks as Transformer layers or blocks, the pre-trained image encoder 350 may include Conformer, Preformer, or other types of multi-head attention layers without departing from the scope of the present disclosure. Continuing with the example, the encoding branch 301 activates, e.g., via the dynamic switching mechanism based on the channel indicator c₁-cₙ associated with the corresponding image modality channel 20, the dedicated set of channel-wise adapter modules 50 that are assigned to the corresponding image modality channel 20. For instance, when processing the last image modality channel 20n, the dynamic switching mechanism uses the corresponding channel indicator cₙ (serving as a modality identity) to activate the dedicated set of channel-wise adapter module 50N₁-Nₙ assigned to the respective image modality channel 20n to adapt the pre-trained image encoder 350. Here, each channel-wise adapter module 50N is added to respective one of the plurality of multi-head attention layers of the image encoder 350. In the example shown, each channel-wise adapter module added to the multi-head attention layers includes a respective Low-Rank Adaptation (LoRA) adapter having two low-rank projection matrices. While the example of FIG. 3 depicts the dynamic switching mechanism activating the respective image modality channels based on the corresponding channel indicator, adaptive switching may also be performed based on the type of downstream task the image analysis model 300 is being trained to perform or scanner, protocol, or site metadata. Optionally, the dynamic switching mechanism may perform switching based on temporal phase or a predefined time point. In some configurations, the adaptive modality switching is learned during the PEFT process 160 through routing or gating techniques. In some scenarios, adaptive switching is based on activation of a single adapter 50 or a weighted combination of multiple adapters.

In the example of FIG. 3, a dedicated LoRA adapter 50N₁ assigned to the last image modality channel 20n is added to the first multi-head attention layer (Layer 1) of the pre-trained encoder 350 for processing the image patches 330 divided from the last image modality channel 20n. The plurality of image patches 330 are provided as input x to each of the first multi-head attention layer (Layer 1) and the LoRA adapter 50N₁ having the two low-rank projection matrices A, B. The first multi-head attention layer (Layer 1) and the LoRA adapter 50N₁ each process the plurality of image patches 330 in parallel to generate corresponding outputs that are concatenated into an intermediate latent encoded representation 225h. Notably, the first multi-head attention layer includes pre-trained encoder weights that remain frozen during the PEFT process 160, while trainable parameters of the LoRA adapter 50N₁ are updated/fine-tuned during the PEFT process 160. Each successive multi-head attention layer of the pre-trained image encoder and corresponding LoRA adapter 50 added thereto receives, as input x, the intermediate latent encoded representation 225h generated by the immediately preceding multi-head attention layer such that the last multi-head attention layer (Layer n) having the dedicated LoRA adapter 50Nₙ generates, as output from the pre-trained audio encoder, the corresponding latent encoded representations 225 for the last image modality channel 20n. While examples herein disclose using LoRA adapters as a PEFT technique for adapting the image encoder, the pre-trained image encoder 350 may be finetuned using other PEFT techniques without departing from the scope of the present disclosure, such as adapters, residual adapters, or other sub-models having trainable parameters for adapting the pertained image encoder to the modality-specific characteristics associated with each imaging modality channel without retraining any of the parameters of the pre-trained vision encoder.

With continued reference to FIG. 3, the latent encoded representations 225 separately generated as output from the pre-trained encoder 350 incorporating the channel-wise adapter modules 50 for each of the image modality channels 20a-n pass through a multi-layer perception (MLP) layer 306 of the encoding branch 301 to reduce parameter count and a concatenator 308 concatenates the latent encoded representations 225 for each of the image modality channels 20a-n into a concatenated set of latent encoded representations 325. The concatenated set of latent encoded representations 325 may correspond to a transformed feature map and a MLP bottleneck layer 312 may increase a resolution by a factor of 2. The CNN decoder 352 (or other task-specific downstream module 352) processes the concatenated set of latent encoded representations 325 to predict a corresponding class 355 for each voxel 206 of the corresponding multi-channel volumetric medical image dataset 204 to classify one or more particular objects (e.g., tumors, tissue, organs). The CNN decoder 352 may further separates each of the particular objects from one another by defining a respective segmentation mask 356 to overly the voxels classifying each object.

During the PEFT process 160, a loss module 375 determines a training loss 380 for each corresponding multi-channel volumetric image dataset 302 based the predicted classes 355 for the voxels 206 output by the CNN decoder 352 and the ground-truth labels 208 paired with the image voxels 206. In some examples the loss module 375 applies a loss function that includes a combined soft dice loss and cross-entropy loss calculated as follows:

$$\text{?}$$

$$\text{?} \text{indicates text missing or illegible when filed}$$

Wherein I is the number of voxels, J is the number of segmentation classes; Y_{i,j} and G_{i,j} denote a probability output and one-hot encoded ground-truth label for class j at voxel I, respectively. The PEFT process 160 updates/fine-tunes parameters of the channel-wise adapter modules 50 and updates parameters of the CNN decoder 352 based on the training loss 380. In some implementations, the PEFT process 160 is configured to account for modalities that are missing from a multi-channel volumetric medical image dataset 204, image modality channels 20 that are optional, reordered inputs, and clinical protocols that evolve overtime.

Referring back to FIG. 1, the self-supervised training process 200 may store the pre-trained image encoder 350 in data storage 180 overlain on the memory hardware 124 of the computing system 120. Likewise, the PEFT process 160 may store the trained image analysis model 300 in the data storage 180. The first computing system 120a and/or any number of second computing systems 120b may access/retrieve the pre-trained image encoder 350 and/or the trained image analysis model 300 for execution thereon.

During inference, the image analysis model 300 incorporating the CNN decoder 352 and the pre-trained image encoder 350 adapted by the fine-tuned channel-wise adapter modules 50 executes on the second computing system 120b (or the first computing system 120a) to process and perform an image analysis task on a raw multi-channel volumetric medical dataset 30 including a plurality of image voxels 206. Notably, the image analysis task performed by the image analysis model 300 may include the downstream vision task (e.g., image segmentation, image classification, clinical endpoint prediction, detection/localization, image registration/alignment, image reconstruction/enhancement/synthesis, and/or multi-task learning) that the image analysis model 300 was to perform by the PEFT process 160. The raw multi-channel volumetric medical dataset 30 includes multiple image modality channels 20a-n. In one scenario, the raw multi-channel volumetric medical dataset 30 includes multi-sequence MRI scans of a target anatomical region of a subject. For instance, the multiple different image modality channels 20, 20a-n may each be associated with respective ones of one or more of native T1-weighted (T1), post-Gadolinium T1-weighted (T1-GD), T2-weighted (T2), T2 FLAIR, DWI sequences or ADC maps derived from a DWI sequence. In another scenario, the raw multi-channel volumetric dataset 30 includes hybrid CT/PET scans of a target anatomical region where a first image modality channel 20a is associated with the CT imaging modality and a second image modality channel 20b is associated with the PET imaging modality. The target anatomical region may correspond to an interior body of the patient, or optionally, an exterior body region of the patient. Each image modality channel 20a may undergo initial image pre-processing 184 to divide into a plurality of image patches 330, 330a-n. While nine (9) image patches is shown by way of example, the example is non-limiting and the pre-processing 184 may divide the image into any number of image patches 330. With reference to FIG. 3, for the image patches 310 divided from each corresponding image modality channel 20, the encoding branch 301 of the image analysis model 310 may use the corresponding channel indicator c to activate the dedicated set of the one or more channel-wise adapter modules 50 fine-tuned by the PEFT 160 and assigned to the corresponding image modality channel 20 such that the encoding branch 301 generates corresponding latent encoded representations 225 for the corresponding image mobility channel 20. Similarly, the encoding branch 301 generates, as output, the corresponding latent encoded representations 225 for each other corresponding image modality channel 20 of the raw multi-channel medical image dataset 30 by activating the dedicated sets of channel-wise adaptor modules 50 assigned to each other image modality channel 20. Thereafter, the latent encoded representation 225 generated separately by the encoding branch 301 for each of the image modality channels 20a-n are concatenated and processed by the CNN decoder 350 to generate an enhanced volumetric medical image 110, 110E and perform the downstream vision task on the enhanced volumetric medical image 110E. When the image analysis model 300 performs the downstream vision task of 3D image segmentation, the CNN decoder 352 predicts a corresponding class for each voxel of the volumetric enhanced medical image 110E to classify one or more particular objects (e.g., tumors, tissue, organs) and separates each of the particular objects from one another by defining a respective segmentation mask to overly the voxels 206 classifying each object.

An image augmenter 360 may receive the enhanced volumetric medical image 110E segmented to identify the voxels 206 that represent each particular object class and generate a corresponding segmentation mask to apply to at least a portion of the voxels 206 representing the particular object class. Accordingly, the image augmenter 360 may augment image voxels 206 in the enhanced image that represent each object class and/or define a boundary of the respective object class. The augmenting of image voxels may include changing a color of the image voxels, adjusting an intensity of the image voxels, or augmenting the image voxels in any suitable manner so that the each object classified is distinguishable and identifiable within the enhanced image 110E. The segmentation mask may include a graphical feature applied to the enhanced image to convey the location of each object class identified in the enhanced image 110E. The image augmenter 360 may output an enhanced augmented image 110, 110A depicting the segmentation masks convey the segmentation results performed by the analysis model 300. A graphical user interface 370 executing on the computing system 120 may display the augmented image 110A on a screen in communication of the computing system 120. Additionally or alternatively, the enhanced image 110E and/or the augmented image 110A may be provided as output to one or more additional downstream tasks.

Referring to FIGS. 2A and 2B, in some implementations, the self-supervised training process 200 pre-trains an image encoder 350 having a masked autoencoder (MAE) architecture (FIG. 2A) or a simple MIM (SimMIM) architecture (FIG. 2B). The self-supervised training processes 200 may pre-train the image encoder 350 using other modeling architectures such as, without limitation, modality-aware joint multi-modal MAE architecture, Distillation with No Labels (DINO) modeling for 3D imaging or DINO-v3-style self-distillation for 3D imaging, Image-based Joint-Embedding Predictive Architecture (I-JEPA), or other predictive embedding modeling architectures. Contrastive to the task of the image analysis model 300 trained to perform vision tasks on volumetric (e.g., 3-dimensional) images, the unannotated images 202 used to by the self-supervised training process 200 to pre-train the image encoder 350 may include two-dimensional images having a plurality of pixels. For each unannotated image 202, the training process 200 first pre-processes the image 202 at a pre-processing stage 184 to divide the image 202 into a plurality of image patches 210, 210a-n. By default, the pre-processing stage 184 may implement a patch size of about 16.

FIG. 2A shows the self-supervised training process 200 training the image encoder 350 having the MAE architecture to reconstruct an original image signal given its partial observation. The MAE architecture includes the image encoder 350 that pass the observed signal (e.g., visible image patch 210) to a latent encoded representation 225, and a lightweight decoder 250 that reconstructs the original signal from the latent encoded representation 225. Notably, the MAE architecture adopts an asymmetric design that allows the image encoder 350 to operate only on the partial, observed signal (without mask tokens [M]) and the lightweight decoder 250 that reconstructs the full signal from the latent encoded representation H 225 and masked tokens [M].

The pre-processing stage 184 samples a subset of the plurality of image patches 210 for input to the image encoder 350 while the remaining image patches 210 are masked and removed. Specifically, the pre-processing stage 184 randomly samples the subset of image patches 210 without replacement and following a uniform distribution. By randomly sampling with a high masking ratio (i.e., the ratio of the masked and removed image patches) helps eliminate redundancy to facilitate creation of a task that cannot be easily solved by extrapolation from visible neighboring image patches 210. The image encoder 250 is only applied on the visible, unmasked image patches to embed the patches 210 by a linear projection with added position embeddings, and then processes the resulting set via a series of multi-head attention layers or blocks (e.g., Transformer blocks). Notably, the image encoder 350 may only operate on a small subset of visible patches 210 sampled from the plurality of image patches 210 divided from the image 202. For instance, the pre-processing stage 184 may randomly sample 25-percent of the image patches 210 as visible patches to be processed by the image encoder 350 while the remaining 75-percent of the image patches 210 are masked and removed. The pre-processing stage 184 may randomly sample image patches as visible patches in ratios greater than or less than 25-percent. The image encoder 350 does not process any of the masked image patches 210m to thereby permit the image encoder 350 to be pre-trained with only a fraction of compute and memory. In the example shown, the image encoder 350 generates, as output, a corresponding latent encoded representation H 225 for each visible image patch 210 randomly sampled from the plurality of image patches 210.

The training process further generates, using an image tokenizer 230 configured to receive the unannotated image 202 as input, a sequence of discrete visual tokens 240 that characterize the corresponding unannotated image 202. The number of visual tokens in the sequence of discrete visual tokens 240 may be equal to the number of image patches 210 divided from the unannotated image 202. The tokenizer 230 may map discrete image pixels from the image 202 into the discrete visual tokens 240 according to a visual codebook that includes a token vocabulary containing discrete token indices. Since the visual tokens 240 are discrete, the training process 200 is non-differentiable. In some examples, the tokenizer 230 is trained via an autoencoding-style reconstruction process where images are tokenized into discrete visual tokens according to a learned vocabulary.

In the example shown, the input to the decoder 250 includes the latent encoded representations 225 output from the image encoder 350 for the visible image patches 210 as well as the masked image patches 210m. The self-supervised training process 200 adds positional embeddings 215 to align the latent encoded representations 225 and the masked image patches 210m. The positional embeddings 215 provide information about the position of each masked image patch 210m in the original image 202. Each masked image patch 210m may be replaced with a special masking embedding [M]. The special masking token [M] may be randomly initialized as a learnable vector optimized to reveal the corresponding masked image patch 210m.

The auxiliary decoder 250 is only used during the self-supervised training process to perform an image reconstruction while only the image encoder 350 is used to produce latent encoded representations 225 for recognition. The training process 200 applies the auxiliary decoder 250 to each masked image patch 210m such that the decoder 250 outputs a vector of pixel values representing each masked image patch 210. A linear projection head 260 may include a number of output channels equal to a number of pixel values in a patch. Accordingly, the output of the auxiliary decoder 250 may be reshaped to form a reconstructed image. In the example shown, the training process 200 only computes a training loss based on only the reconstructed masked patches 210m. Thereafter, the training process 200 updates parameters of the image encoder 350 (and optionally the decoder 250) based on the training loss. The decoder 250 may include a plurality of multi-head attention layers (e.g., Transformer layers).

FIG. 2B shows the self-supervised training process 200 training the image encoder 350 having the SimMIM architecture by randomly masking a portion of the image patches 210 divided from a corresponding unannotated image 202. Each image patch 210 may be represented by a corresponding set of pixel values. The training process 200 further randomly masks the portion of the image patches 210 by using one of a central region masking strategy, a block-wise masking strategy, or a uniformly random masking strategy that uses different masked patch sizes and masking ratios.

In the example shown, the self-supervised training process 200 adds positional embeddings 215 to the image patches 210. The image encoder 350 receives each masked image patch 210M, whereby each masked image patch may be replaced with a special masking embedding [M]. The special masking token [M] may be randomly initialized as a learnable vector optimized to reveal the corresponding masked image patch 210.

For each masked image patch 210M, the image encoder 350 is configured to generate a corresponding latent encoded representation 225 and a prediction head 260 generates predicted pixel values 270 for the masked image patch 210M. Notably, the self-supervised training process 200 for pre-training the image encoder 350 having the SimMIM architecture omits a decoder and instead implements the prediction head 260 to predict raw pixel values 270 for each masked image patch 210M directly from the latent encoded representation 225 generated by the image encoder 350 for the corresponding masked image patch 210M. The training process 200 may determine a training loss based on the predicted pixel values 270 generated for the masked image patches and the corresponding sets of raw pixel values from the original unannotated image 202 that represent the masked image patches.

The training loss may be based on a distance in a pixel space between the recovered/estimated raw pixel values 270 and the original voxels from the corresponding sets of raw voxel values that represent the masked image patches. The training loss may include either an l₁ or l₂ loss function. Notably, the training loss may only be computed for the masked matches 210M to prevent the encoder 350 from engaging in self-reconstruction and potentially dominate the learning process and ultimately impeded knowledge learning. Thereafter, the training process 200 updates parameters of the image encoder 350 based on the training loss. The projection head 260 can transform the predicted tokens 270 to the original pixel space when the pre-processing down samples the resolution of the image 202. Optionally, a two-layer convolutional transpose can up sample the compressed latent encoded representations 225 to the resolution of the original image 202.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

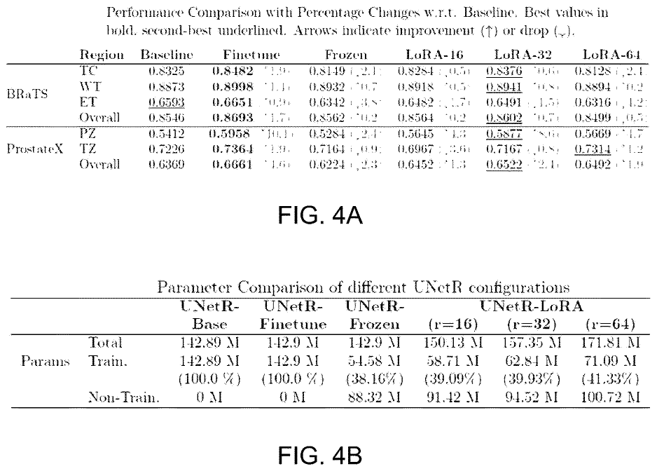

An image analysis model having the UNETR architecture was subjected to training and evaluation under four distinct configurations: (1) training the UNETR model from scratch (Baseline); (2) full fine-tuning of the pre-trained image encoder (Finetune); (3) decoder-only fine-tuning with frozen pre-trained encoder (Frozen); and (4) performing the PEFT process 160 by updating/fine-tuning parameters of the channel-wise adapter modules 50 incorporated into the pre-trained encoder (LoRA), as disclosed in FIGS. 1 and 3. The models are each trained/fine-tuned on the BRaTS dataset and evaluated for segmenting TC, WT, ET, and overall regions. The models are also each trained/fine-tuned on the ProstateX dataset and evaluated for segmenting PZ, TZ, and overall regions. The effect of LoRA rank (r=16, 32, 64) was evaluated on performance and parameter efficiency. All models were trained for 200 epochs using Adam optimizer with OneCycleLR scheduler (max LR=0.005) and optimized using a combined Dice and cross-entropy loss. Model performance for segmentation was assessed using Dice Score threshold at 0.5. The experimental results from the four different configurations are summarized in the Table of FIG. 4A. Here, the Table of FIG. 4A depicts the performance comparison with percentage changes with respect to the Baseline, wherein best values are in bold text and second-best values are underlined. Additionally, upward arrows indicate a performance improvement, and downward arrows indicate a performance drop. FIG. 4B depicts a parameter comparison of the four different configurations. Notably, the UNETR-LoRA achieves performance comparable to full fine-tuning, while significantly reducing the number of trainable parameters (Table 2) and outperforming decoder-only and baseline configurations. Thus, the UNETR-LORA provides a significant improvement in training image analysis models on multi-channel volumetric image sets by drastically reducing the number of trainable parameters (e.g., a 40% reduction in trainable parameters) without a loss in performance.

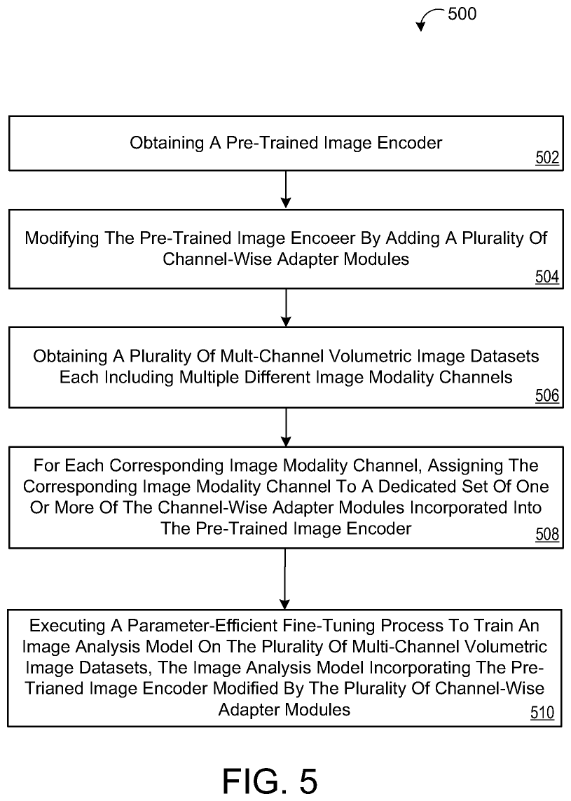

FIG. 5 is a flowchart of an example arrangement of operations for a method 500 of using a parameter-efficient fine-tuning (PEFT) process 160 to train an image analysis model 300 to learn how to perform a downstream vision task on multi-channel volumetric image datasets. The method 500 may execute on data processing hardware 1510 (FIG. 7) based on the data processing hardware 1510 executing instructions stored on memory hardware 1520 (FIG. 7) that causes the data processing hardware 1510 to perform the operations. At operation 502, the method 500 includes obtaining a pre-trained image encoder 350, and at operation 504, the method 500 includes modifying the pre-trained image encoder 350 by incorporating, into the pre-trained image encoder, a plurality of channel-wise adapter modules 50.

At operation 506, the method 500 includes obtaining a plurality of multi-channel volumetric image datasets 204 each including multiple different image modality channels 20. Here, each multi-channel volumetric image dataset 204 includes a plurality of image voxels 206 each paired with a corresponding ground-truth label 208 indicating a class the corresponding image voxel 206 belongs to.

At operation 508, for each corresponding image modality channel 20 among the multiple different image modality channels 20, the method 500 includes assigning the corresponding image modality channel 20 to a dedicated set of one or more of the channel-wise adapter modules 50 from the plurality of channel-wise adapter modules 50 incorporated into the pre-trained image encoder 350. At operation 510, the method 500 includes executing the PEFT process 160 to train the image analysis model 300 on the plurality of multi-channel volumetric image datasets 204 to teach the image analysis model 350 to learn how to perform the downstream vision task on multi-channel volumetric image datasets. The image analysis model 300 incorporates the pre-trained image encoder 350 modified by the plurality of channel-wise adapter modules 50. The PEFT process 160 trains the image analysis model 300 by fine-tuning parameters of the plurality of channel-wise adapter modules 50 while parameters of the pre-trained image encoder 350 are held fixed. The downstream vision task the image analysis model 300 is trained to perform may include image segmentation and/or classification, clinical endpoint prediction, detection and localization tasks, registration/alignment, image reconstruction/enhancement, or multi-task learning.

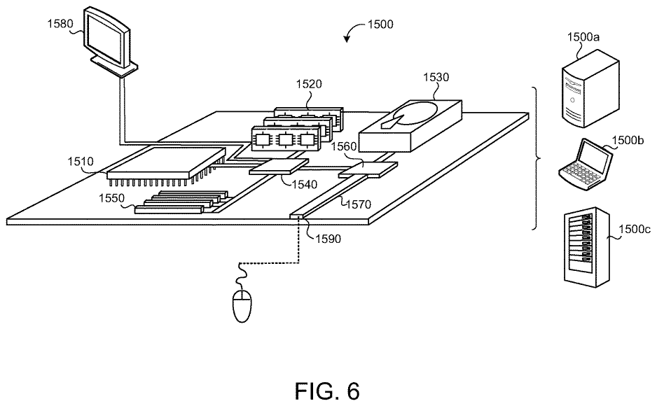

FIG. 6 is schematic view of an example computing device 1500 that may be used to implement the systems and methods described in this document. The computing device 1500 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 1500 includes a processor 1510, memory 1520, a storage device 1530, a high-speed interface/controller 1540 connecting to the memory 1520 and high-speed expansion ports 1550, and a low speed interface/controller 1560 connecting to a low speed bus 1570 and a storage device 1530. Each of the components 1510, 1520, 1530, 1540, 1550, and 1560, are interconnected using various busses, and may be mounted on a common motherboard or in other manners as appropriate. The processor 1510 (e.g., data processing hardware) can process instructions for execution within the computing device 1500, including instructions stored in the memory 1520 or on the storage device 1530 to display graphical information for a graphical user interface (GUI) on an external input/output device, such as display 1580 coupled to high speed interface 1540. The data processing hardware 1510 may include the data processing hardware In other implementations, multiple processors and/or multiple buses may be used, as appropriate, along with multiple memories and types of memory. Also, multiple computing devices 1500 may be connected, with each device providing portions of the necessary operations (e.g., as a server bank, a group of blade servers, or a multi-processor system).

The memory 1520 stores information non-transitorily within the computing device 1500. The memory 1520 may be a computer-readable medium, a volatile memory unit(s), or non-volatile memory unit(s). The non-transitory memory 1520 may be physical devices used to store programs (e.g., sequences of instructions) or data (e.g., program state information) on a temporary or permanent basis for use by the computing device 1500. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 1530 is capable of providing mass storage for the computing device 1500. In some implementations, the storage device 1530 is a computer-readable medium. In various different implementations, the storage device 1530 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 1520, the storage device 1530, or memory on processor 1510.

The high speed controller 1540 manages bandwidth-intensive operations for the computing device 1500, while the low speed controller 1560 manages lower bandwidth-intensive operations. Such allocation of duties is exemplary only. In some implementations, the high-speed controller 1540 is coupled to the memory 1520, the display 1580 (e.g., through a graphics processor or accelerator), and to the high-speed expansion ports 1550, which may accept various expansion cards (not shown). In some implementations, the low-speed controller 1560 is coupled to the storage device 1530 and a low-speed expansion port 1590. The low-speed expansion port 1590, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 1500 may be implemented in a number of different forms, as shown in the figure. For example, it may be implemented as a standard server 1500a or multiple times in a group of such servers 1500a, as a laptop computer 1500b, or as part of a rack server system 1500c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executed on data processing hardware causes the data processing hardware to perform operations comprising:
obtaining a pre-trained image encoder;
modifying the pre-trained image encoder by incorporating, into the pre-trained image encoder, a plurality of channel-wise adapter modules;
obtaining a plurality of multi-channel volumetric image datasets each including multiple different image modality channels, each multi-channel volumetric image dataset including a plurality of image voxels each paired with a corresponding ground-truth label indicating a class the corresponding image voxel belongs to;
for each corresponding image modality channel among the multiple different image modality channels, assigning the corresponding image modality channel to a dedicated set of one or more of the channel-wise adapter modules from the plurality of channel-wise adapter modules incorporated into the pre-trained image encoder; and
executing a parameter-efficient fine-tuning (PEFT) process to train an image analysis model on the plurality of multi-channel volumetric image datasets to teach the image analysis model to learn how to perform a downstream vision task on multi-channel volumetric image datasets, the image analysis model incorporating the pre-trained image encoder modified by the plurality of channel-wise adapter modules and the PEFT process training the image analysis model by fine-tuning parameters of the plurality of channel-wise adapter modules while parameters of the pre-trained image encoder are held fixed.

2. The computer-implemented method of claim 1, wherein the multiple image modality channels of each corresponding multi-channel volumetric image dataset are co-registered.

3. The computer-implemented method of claim 1, wherein:
the pre-trained image encoder comprises a plurality of multi-head attention layers;
assigning the corresponding image modality channel to the dedicated set of the one or more of the channel-wise adapter modules comprises assigning the corresponding image modality channel to a corresponding dedicated set of multiple channel-wise adapter modules from the plurality of channel-wise adapter modules incorporated into the pre-trained image encoder; and
each channel-wise adapter module in the corresponding dedicated set of multiple channel-wise adapter modules assigned to the corresponding image modality channel is added to a respective one of the plurality of multi-head attention layers.

4. The computer-implemented method of claim 1, wherein executing the PEFT process comprises, for each corresponding multi-channel volumetric image dataset:
for each corresponding image modality channel among the multiple different image modality channels of the corresponding multi-channel volumetric image data set:
dividing the corresponding image modality channel into a plurality of image patches;
activating each channel-wise adapter module in the dedicated set of the one or more channel-wise adapter modules assigned to the corresponding image modality channel to adapt the pre-trained image encoder for processing the corresponding image modality channel separately from each other image modality channel in the corresponding multi-channel volumetric image dataset; and
processing, using the pre-trained encoder and each activated channel-wise adapter module in the dedicated set of the one or more channel-wise adapter modules assigned to the corresponding image modality channel, the image patches divided from the corresponding image modality channel to generate corresponding latent encoded representations for the corresponding image modality channel;
concatenating the latent encoded representations separately generated for each of the multiple different image modality channels into a concatenated set of latent encoded representations;
processing, using a decoder of the image analysis model, the concatenated set of latent encoded representation to predict a corresponding class for each voxel of the corresponding multi-channel volumetric medical image dataset;
determining a training loss for the corresponding multi-channel volumetric image dataset based on the predicted classes for the voxels and the ground-truth labels paired with the voxels; and
fine-tuning the parameters of the channel-wise adapter modules based on the training loss while parameters of the pre-trained image encoder remain fixed.

5. The computer-implemented method of claim 4, wherein fine-tuning the parameters of the channel-wise adapter modules further comprises updating parameters of the decoder based on the training loss.

6. The computer-implemented method of claim 4, wherein, when processing the image patches divided from the corresponding image modality channel to generate the corresponding latent encoded representations for the corresponding image modality channel, each channel-wise adapter module in the dedicated sets of one or more adapter modules assigned to the other image modality channels are deactivated.

7. The computer-implemented method of claim 1, wherein executing the PEFT process comprises, for each corresponding multi-channel volumetric image dataset:
for each corresponding image modality channel among the multiple different image modality channels of the corresponding multi-channel volumetric image data set:
dividing the corresponding image modality channel into a plurality of image patches;
activating each channel-wise adapter module in the dedicated set of the one or more channel-wise adapter modules assigned to the corresponding image modality channel to adapt the pre-trained image encoder for processing the corresponding image modality channel separately from each other image modality channel in the corresponding multi-channel volumetric image dataset; and
processing, using the pre-trained encoder and each activated channel-wise adapter module in the dedicated set of the one or more channel-wise adapter modules assigned to the corresponding image modality channel, the image patches divided from the corresponding image modality channel to generate corresponding latent encoded representations for the corresponding image modality channel;
concatenating the latent encoded representations separately generated for each of the multiple different image modality channels into a concatenated set of latent encoded representations;
processing, using a downstream module of the image analysis model, the concatenated set of latent encoded representation to predict a corresponding class for each voxel of the corresponding multi-channel volumetric medical image dataset;
determining a training loss for the corresponding multi-channel volumetric image dataset based on the predicted classes for the voxels and the ground-truth labels paired with the voxels; and
fine-tuning the parameters of the channel-wise adapter modules based on the training loss while parameters of the pre-trained image encoder remain fixed.

8. The computer-implemented method of claim 7, wherein fine-tuning the parameters of the channel-wise adapter modules further comprises updating parameters of the downstream module based on the training loss.

9. The computer-implemented method of claim 7, wherein the downstream module comprises at least one of a decoder or one or more prediction heads.

10. The computer-implemented method of claim 1, wherein the multiple different image modality channels are associated with a multi-sequence magnetic resonance imaging (MRI) of a target anatomical region obtained by an MRI scanner.

11. The computer-implemented method of claim 10, wherein the multiple different image modality channels include two or more of a T1-weighted sequence, a T2-weighted sequence, a T2 Fluid-Attenuated Inversion Recovery (FLAIR) sequence, a Diffusion-Weighted Imaging (DWI) sequence, or a Apparent Diffusion Coefficient (ADC) map.

12. The computer-implemented method of claim 1, wherein the multiple different modality channels include a first modality channel associated with positron emission tomography (PET) scan of a target anatomical region and a second modality channel associated with a computed tomography (CT) scan of the same target anatomical region.

13. A system comprising:
data processing hardware; and
memory hardware in communication with the data processing hardware and storing instructions that when executed on the data processing hardware causes the data processing hardware to perform operations comprising:
obtaining a pre-trained image encoder;
modifying the pre-trained image encoder by incorporating, into the pre-trained image encoder, a plurality of channel-wise adapter modules;
obtaining a plurality of multi-channel volumetric image datasets each including multiple different image modality channels, each multi-channel volumetric image dataset including a plurality of image voxels each paired with a corresponding ground-truth label indicating a class the corresponding image voxel belongs to;
for each corresponding image modality channel among the multiple different image modality channels, assigning the corresponding image modality channel to a dedicated set of one or more of the channel-wise adapter modules from the plurality of channel-wise adapter modules incorporated into the pre-trained image encoder; and
executing a parameter-efficient fine-tuning (PEFT) process to train an image analysis model on the plurality of multi-channel volumetric image datasets to teach the image analysis model to learn how to perform a downstream vision task on multi-channel volumetric image datasets, the image analysis model incorporating the pre-trained image encoder modified by the plurality of channel-wise adapter modules and the PEFT process training the image analysis model by fine-tuning parameters of the plurality of channel-wise adapter modules while parameters of the pre-trained image encoder are held fixed.

14. The system of claim 13, wherein the multiple image modality channels of each corresponding multi-channel volumetric image dataset are co-registered.

15. The system of claim 13, wherein:
the pre-trained image encoder comprises a plurality of multi-head attention layers;
assigning the corresponding image modality channel to the dedicated set of the one or more of the channel-wise adapter modules comprises assigning the corresponding image modality channel to a corresponding dedicated set of multiple channel-wise adapter modules from the plurality of channel-wise adapter modules incorporated into the pre-trained image encoder; and
each channel-wise adapter module in the corresponding dedicated set of multiple channel-wise adapter modules assigned to the corresponding image modality channel is added to a respective one of the plurality of multi-head attention layers.

16. The system of claim 13, wherein executing the PEFT process comprises, for each corresponding multi-channel volumetric image dataset:
for each corresponding image modality channel among the multiple different image modality channels of the corresponding multi-channel volumetric image data set:
dividing the corresponding image modality channel into a plurality of image patches;
activating each channel-wise adapter module in the dedicated set of the one or more channel-wise adapter modules assigned to the corresponding image modality channel to adapt the pre-trained image encoder for processing the corresponding image modality channel separately from each other image modality channel in the corresponding multi-channel volumetric image dataset; and
processing, using the pre-trained encoder and each activated channel-wise adapter module in the dedicated set of the one or more channel-wise adapter modules assigned to the corresponding image modality channel, the image patches divided from the corresponding image modality channel to generate corresponding latent encoded representations for the corresponding image modality channel;
concatenating the latent encoded representations separately generated for each of the multiple different image modality channels into a concatenated set of latent encoded representations;
processing, using a decoder of the image analysis model, the concatenated set of latent encoded representation to predict a corresponding class for each voxel of the corresponding multi-channel volumetric medical image dataset;
determining a training loss for the corresponding multi-channel volumetric image dataset based on the predicted classes for the voxels and the ground-truth labels paired with the voxels; and
fine-tuning the parameters of the channel-wise adapter modules based on the training loss while parameters of the pre-trained image encoder remain fixed.

17. The system of claim 16, wherein fine-tuning the parameters of the channel-wise adapter modules further comprises updating parameters of the decoder based on the training loss.

18. The system of claim 16, wherein, when processing the image patches divided from the corresponding image modality channel to generate the corresponding latent encoded representations for the corresponding image modality channel, each channel-wise adapter module in the dedicated sets of one or more adapter modules assigned to the other image modality channels are deactivated.

19. The system of claim 13, wherein executing the PEFT process comprises, for each corresponding multi-channel volumetric image dataset:
for each corresponding image modality channel among the multiple different image modality channels of the corresponding multi-channel volumetric image data set:
dividing the corresponding image modality channel into a plurality of image patches;
activating each channel-wise adapter module in the dedicated set of the one or more channel-wise adapter modules assigned to the corresponding image modality channel to adapt the pre-trained image encoder for processing the corresponding image modality channel separately from each other image modality channel in the corresponding multi-channel volumetric image dataset; and
processing, using the pre-trained encoder and each activated channel-wise adapter module in the dedicated set of the one or more channel-wise adapter modules assigned to the corresponding image modality channel, the image patches divided from the corresponding image modality channel to generate corresponding latent encoded representations for the corresponding image modality channel;
concatenating the latent encoded representations separately generated for each of the multiple different image modality channels into a concatenated set of latent encoded representations;
processing, using a downstream module of the image analysis model, the concatenated set of latent encoded representation to predict a corresponding class for each voxel of the corresponding multi-channel volumetric medical image dataset;
determining a training loss for the corresponding multi-channel volumetric image dataset based on the predicted classes for the voxels and the ground-truth labels paired with the voxels; and
fine-tuning the parameters of the channel-wise adapter modules based on the training loss while parameters of the pre-trained image encoder remain fixed.

20. The system of claim 19, wherein fine-tuning the parameters of the channel-wise adapter modules further comprises updating parameters of the downstream module based on the training loss.

21. The system of claim 19, wherein the downstream module comprises at least one of a decoder or one or more prediction heads.

22. The system of claim 13, wherein the multiple different image modality channels are associated with a multi-sequence magnetic resonance imaging (MRI) of a target anatomical region obtained by an MRI scanner.

23. The system of claim 22, wherein the multiple different image modality channels include two or more of a T1-weighted sequence, a T2-weighted sequence, a T2 Fluid-Attenuated Inversion Recovery (FLAIR) sequence, a Diffusion-Weighted Imaging (DWI) sequence, or a Apparent Diffusion Coefficient (ADC) map.

24. The system of claim 13, wherein the multiple different modality channels include a first modality channel associated with positron emission tomography (PET) scan of a target anatomical region and a second modality channel associated with a computed tomography (CT) scan of the same target anatomical region.

25. A computer-implemented method executing on data processing hardware that causes the data processing hardware to perform operations comprising:
receiving a multi-channel volumetric image dataset including multiple different image modality channels, each image modality channel of the multiple different image modality channels assigned to a dedicated set of one or more channel-wise adapter modules incorporated into a pre-trained image encoder;
for each corresponding image modality channel of the multiple image modality channels:
dividing the corresponding image modality channel into a plurality of image patches;
activating each channel-wise adapter module in the dedicated set of the one or more channel-wise adapter modules assigned to the corresponding image modality channel to adapt the pre-trained image encoder for processing the corresponding image modality channel separately from each other image modality channel in the corresponding multi-channel volumetric image dataset; and
processing, using the pre-trained encoder and each activated channel-wise adapter module in the dedicated set of the one or more channel-wise adapter modules assigned to the corresponding image modality channel, the image patches divided from the corresponding image modality channel to generate corresponding latent encoded representations for the corresponding image modality channel;
concatenating the latent encoded representations separately generated for each of the multiple different image modality channels into a concatenated set of latent encoded representations; and
processing, using a task-specific downstream module of the image analysis model, the concatenated set of latent encoded representations to generate an enhanced volumetric image.

26. The computer-implemented method of claim 25, wherein processing, using the task-specific downstream module of the image analysis module, the concatenated set of latent encoded representations further comprises processing the concatenated set of latent encoded representations to predict a corresponding class for each voxel of the enhanced volumetric image to classify one or more target objects.

27. The computer-implemented method of claim 26, wherein processing, using the task-specific downstream module of the image analysis model, the concatenated set of latent encoded representations further comprises processing the concatenated set of latent encoded representations to separate each of the one or more target objects from one another by defining a respective segmentation mask to overly on the voxels classifying each target object.
